(19) United States
(12) Patent Application Publication
(10) Pub. No.: US 2020/0250760 A1
(43) Pub. Date: Aug. 6, 2020

(54) DYNAMIC ASSET ALLOCATION AND VISUALIZATION

(71) Applicant: OPTIMAL ASSET MANAGEMENT, INC., Los Altos, CA (US)

(72) Inventor: Vijay Vaidyanathan, Los Altos, CA (US)

(21) Appl. No.: 16/782,989

(22) Filed: Feb. 5, 2020

Related U.S. Application Data
(60) Provisional application No. 62/801,613, filed on Feb. 5, 2019.

(51) Int. Cl. G06Q 40/06; G06F 16/25; G06F 16/26

(52) U.S. Cl. CPC G06Q 40/06; G06F 16/26; G06F 16/252

(57) ABSTRACT

Systems and methods for dynamic asset allocation and visualization are provided. An outcome shaping engine may be executed to identify an asset allocation strategy that is specifically targeted towards achieving a defined goal. Such targeting may result in an asset allocation that has been selected to maximize the likelihood of reaching a specified financial goal (rather than generally maximizing return or a generally minimizing risk). In addition, a graphical representation may be generated to illustrate a plurality of possible outcomes associated with a set of asset allocation parameters.

### CROSS-REFERENCE TO RELATED APPLICATIONS

The present patent application claims the priority benefit of U.S. provisional patent application No. 62/801,613, the disclosure of which is incorporated by reference herein.

### BACKGROUND OF THE INVENTION

### 1. Field of the Invention

The present invention generally relates to asset allocation. More specifically, the present invention relates to dynamic asset allocation and visualization.

### 2. Description of the Related Art

Presently available asset allocation models are based on an identified level of risk tolerance (e.g., “aggressive” vs. “asset protection”). Investments may thereafter be channeled to certain portfolios or other investment vehicles based on the identified risk tolerance. The initial asset allocation may therefore after re-balanced at predetermined periods (e.g., annually, quarterly) in accordance with the initially identified level of risk tolerance. The likely outcomes from such investment models generally fall along a bell curve albeit with different centers and widths in accordance with the identified level of risk tolerance.

Whereas such systems may be inflexible and not tailored to specific goals of the individual, most individuals lack the knowledge and/or tools to allocate their own investments.

There is, therefore, a need in the art for improved systems and methods for dynamic asset allocation and visualization.

### SUMMARY OF THE CLAIMED INVENTION

Embodiments of the present invention provide for dynamic asset allocation and visualization. An outcome shaping engine may be executed to identify an asset allocation strategy that is specifically targeted towards achieving a defined goal. Such targeting may result in an asset allocation that has been selected to maximize the likelihood of reaching a specified financial goal (rather than generally maximizing return or a generally minimizing risk). In addition, a graphical representation may be generated to illustrate a plurality of possible outcomes associated with a set of asset allocation parameters.

### BRIEF DESCRIPTION OF THE FIGURES

FIG. 1 is a screenshot of an exemplary graphical user interface that receives a set of user-inputted asset allocation parameters.

FIG. 2A is a screenshot of an exemplary graphical user interface that visually presents a summary of asset allocation predictions.

FIG. 2B is a screenshot of an exemplary graphical user interface that visually presents a range of possible outcomes that may result based on an initial set of asset allocation parameters.

FIG. 3 is a flowchart illustrating an exemplary method for dynamic asset allocation and visualization.

FIG. 4 is a block diagram of an exemplary computing device that may be used to implement an embodiment of the present invention.

### DETAILED DESCRIPTION

Embodiments of the present invention provide for dynamic asset allocation and visualization. An outcome shaping engine may be executed to identify an asset allocation strategy that is specifically targeted towards achieving a defined goal. Such targeting may result in an asset allocation that has been selected to maximize the likelihood of reaching a specified financial goal (rather than generally maximizing return or a generally minimizing risk). In addition, a graphical representation may be generated to illustrate a plurality of possible outcomes associated with a set of asset allocation parameters.

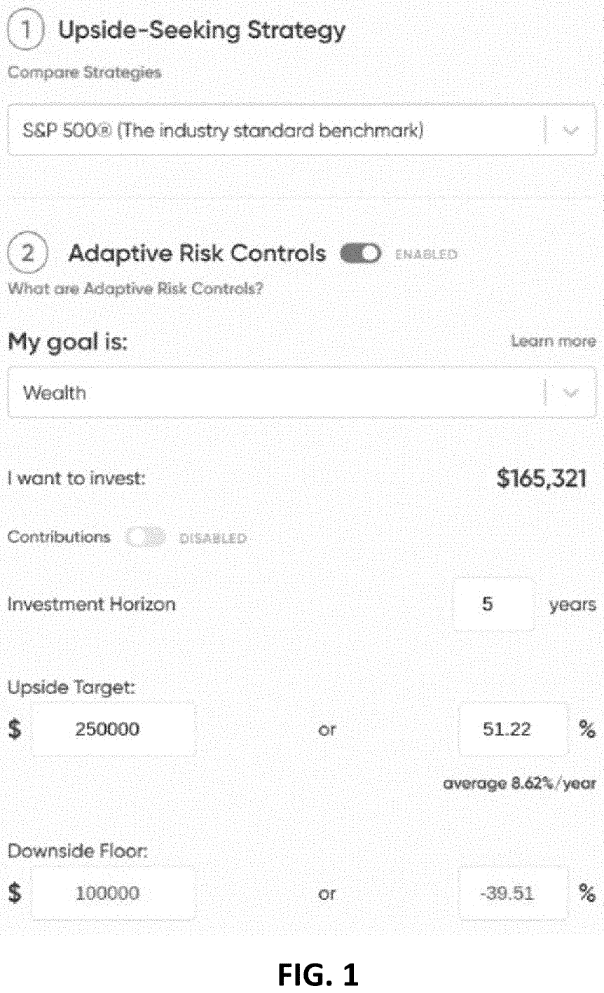

FIG. 1 is a screenshot of an exemplary graphical user interface that receives a set of user-inputted asset allocation parameters. Rather than simply seeking to classify risk tolerance, the outcome shaping engine may consider a set of key factors or parameters, including target date, a minimum acceptable outcome, and a target outcome. Target dates may be set for any time in the future and may vary based on the type of goal (e.g., short-term investment for planned purchases, long-term investment for retirement). The minimum acceptable outcome (or “floor”) is the worst possible return (e.g., highest level of loss) that the user is willing to accept. While related to risk tolerance defined based on predetermined ranges (e.g., “aggressive” range), the outcome shaping engine uses the minimum acceptable outcome to set a specific floor so as to avoid outcomes that fall below the set floor. The target outcome is an identified goal and may be expressed as a specific amount or as a percentage of growth.

As illustrated in FIG. 1, a user may input the set of key factors, which may include a goal type, a goal date, an initial starting amount, an upside target (e.g., by amount or percentage), and a downside floor (e.g., by amount or percentage). Goal types may include a wealth target, an income target, meeting loan payments, saving for college, annuity-like payments, etc. For example, the user may identify a specific wealth target for an investment period of five (5) years, a starting investment amount of $165,321, an upside target (e.g., yearly upside target of $12,000 or a total target of $250,000), and a downside floor (e.g., yearly downside floor of $7500 or a total downside floor of $100,000).

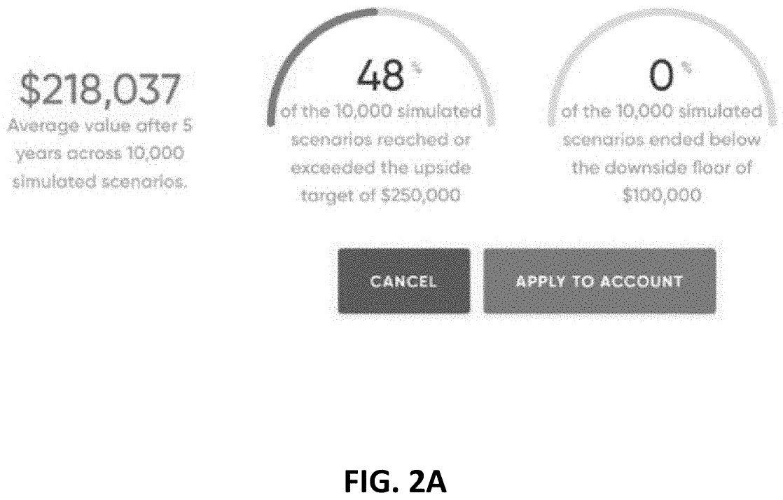

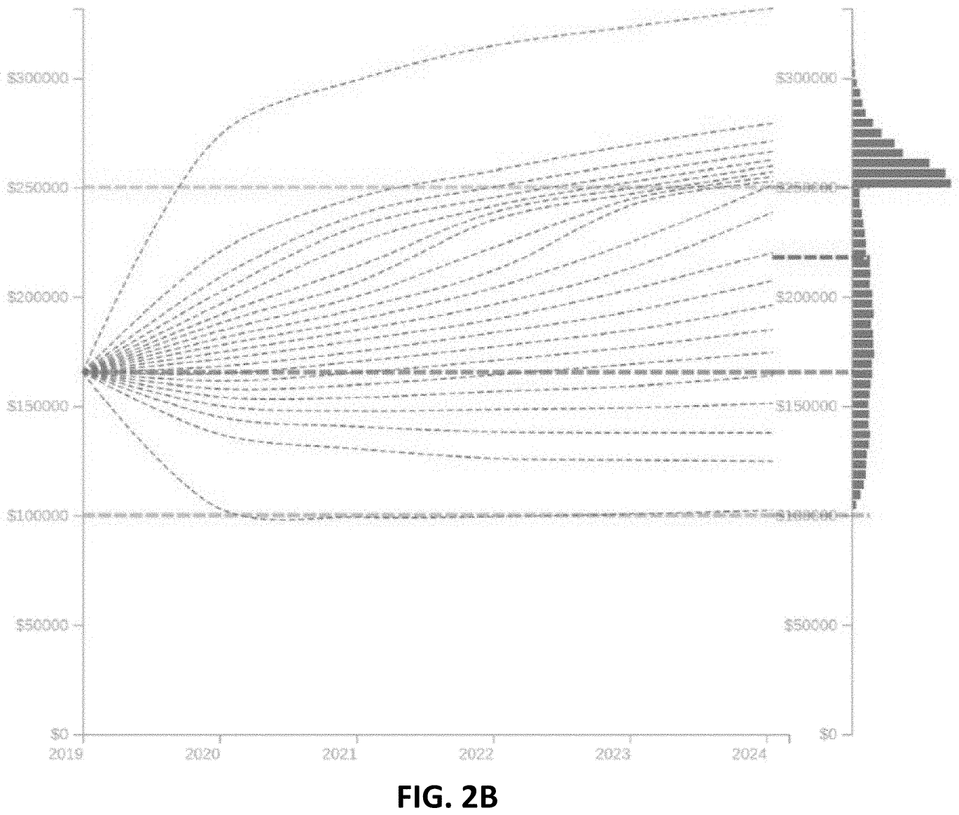

An outcome shaping engine may thereafter be executed to run a plurality of simulations to identify possible outcomes that may result from investing the initial investment amount over the course of the investment period in accordance with one or more asset allocations. The outcome shaping engine may therefore use such user-specific factors to generate possible outcomes from asset allocation(s) specifically selected to avoid falling below a set floor and to maximize the likelihood of hitting the specified target outcome. Such outcomes may be summarized and visualized as illustrated in FIGS. 2A-2B.

FIG. 2A is a screenshot of an exemplary graphical user interface that visually presents a summary of asset allocation predictions. FIG. 2B is a screenshot of an exemplary graphical user interface that visually presents a range of possible outcomes that may result based on an initial set of asset allocation parameters. The visualization provided above further illustrates a range of possible outcomes that may result based on an asset allocation for an initial starting investment of about $165 k, a floor of 100 k, and a target goal of reaching $250 k within 5 years. The light dashed lines represent the different possible outcomes that may result. The illustrated visualization above specifically presents the light dashed lines in accordance with isopercentiles where each line represents a 5% probability.

In addition, the vertical histogram represents the distribution of likely outcomes. As illustrated, no outcome is predicted to fall below the floor, and the likeliest outcome is predicted to meet the target goal. As detailed in the attached appendix, such distribution may be identified based on a number of simulations where 0% of the simulations ended below the $100 k floor and 48% of the simulations reached or exceeded the target outcome of $250 k. Because the outcome shaping engine is geared towards such specific factors, the distribution of the histogram does not fall into a traditional bell curve shape.

Such visualization may be used to set and/or adjust goals as users may compare different asset allocations that may result from different starting points, timespans, floors, and target outcomes. Once the asset allocation has been approved, the outcome shaping engine may store the same in conjunction with the user profile, which may be used to automatically re-balance the asset allocation in real-time.

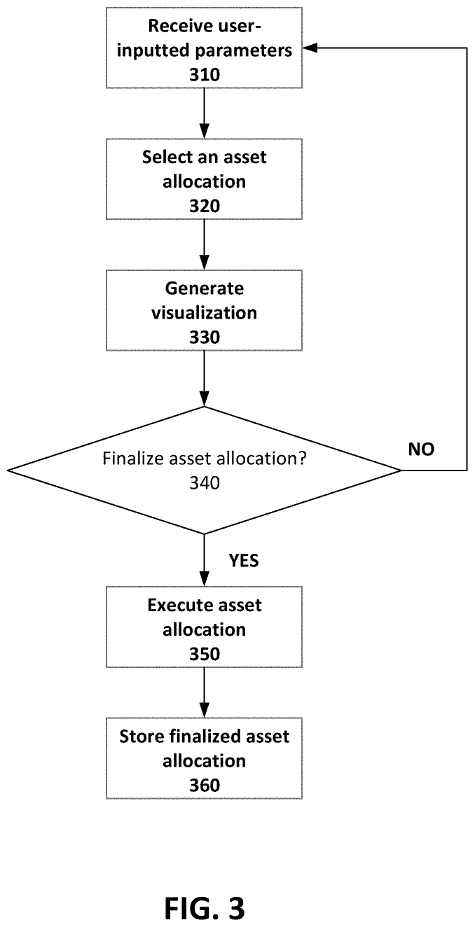

FIG. 3 is a flowchart illustrating an exemplary method for dynamic asset allocation and visualization. The method of FIG. 3 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 3 (and the order thereof) are exemplary and may include various alternatives, equivalents, or derivations thereof including but not limited to the order of execution of the same.

In step 310, the user may enter a set of parameters into an outcome shaping tool. The outcome shaping tool may be an application stored in memory and executable by a processor to generate a graphic user interface, such as that illustrated in FIG. 1. Such graphic user interface includes various fields regarding various aspects of investment goals targeted by the user. Such parameters may include inter alia goal type, goal date, initial starting amount, upside target, and downside floor.

In step 320, the outcome shaping tool may be executed to select an asset allocation based on the user-inputted parameters. In particular, the asset allocation is selected to avoid dropping below the downside floor, while maximizing the odds of hitting the upside target. The asset allocation may be selected based on running simulations to identify the possible outcomes and filtering the results in accordance with the user-inputted parameters.

In step 330, a visualization may be generated to illustrate the predicted outcomes. Such a visualization may be presented as a graphic user interface such as illustrated in FIG. 2B. The visualization may include isopercentile lines that each correspond to a predetermined percentage range of the possible outcomes throughout the predetermined time period. Such isopercentile lines are at or above the minimum acceptable outcome (e.g., the downsid floor). The visualization may further include a histogram comprising a plurality of histogram bars each corresponding to a cumulative likelihood of each of the possible outcomes. The histogram may be aligned in accordance with the possible outcomes illustrated by the plurality of isopercentile lines.

In step 340, it may be determined whether the asset allocation is finalized. If not, the method returns to step 310 where the user is given another opportunity to adjust any of the user-inputted parameters. The adjusted parameters may thereafter be used to dynamically update the asset allocation and associated predictions and visualizations. If the asset allocation is finalized, the method may proceed to step 350.

In step 350, the asset allocation—specifically, the investments within the asset allocation—may be executed. Various buying or selling actions may be performed automatically in accordance with the identified asset allocation, or transmitted to a designated recipient for execution. In step 360, the finalized asset allocation may be stored in memory in association with a user profile of the user.

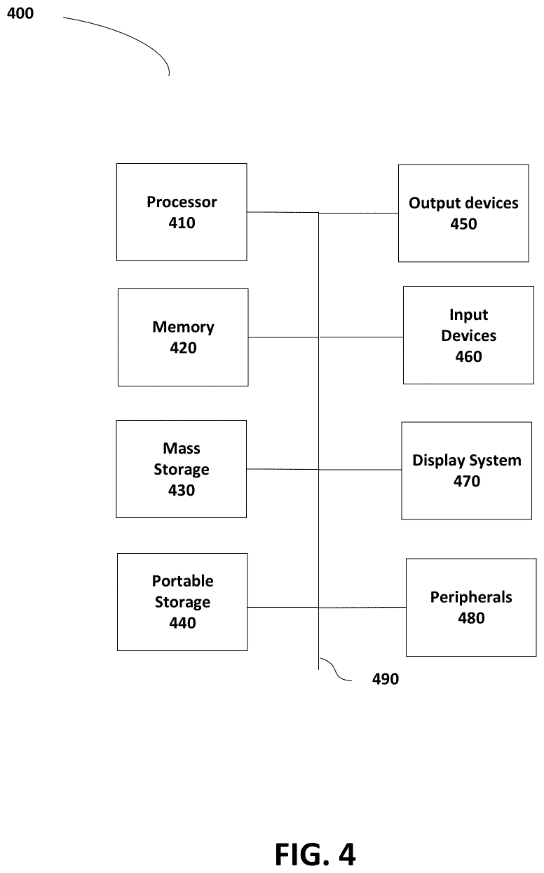

FIG. 4 illustrates an exemplary computing system 400 that may be used to implement an embodiment of the present invention. The computing system 400 of FIG. 4 includes one or more processors 410 and memory 420. Main memory 420 stores, in part, instructions and data for execution by processor 410. Main memory 420 can store the executable code when in operation. The system 400 of FIG. 4 further includes a mass storage device 430, portable storage medium drive(s) 440, output devices 450, user input devices 460, a graphics display 470, and peripheral devices 480.

The components shown in FIG. 4 are depicted as being connected via a single bus 490. However, the components may be connected through one or more data transport means. For example, processor unit 410 and main memory 420 may be connected via a local microprocessor bus, and the mass storage device 430, portable storage device 440, display system 470, and peripheral device(s) 480 may be connected via one or more input/output (I/O) buses.

Mass storage device 430, which may be implemented with a magnetic disk drive or an optical disk drive, is a non-volatile storage device for storing data and instructions for use by processor unit 410. Mass storage device 430 can store the system software for implementing embodiments of the present invention for purposes of loading that software into main memory 420.

Portable storage device 440 operates in conjunction with a portable non-volatile storage medium, such as a floppy disk, compact disk or Digital video disc, to input and output data and code to and from the computer system 400 of FIG. 4. The system software for implementing embodiments of the present invention may be stored on such a portable medium and input to the computer system 400 via the portable storage device 440.

Input devices 460 provide a portion of a user interface. Input devices 460 may include an alpha-numeric keypad, such as a keyboard, for inputting alpha-numeric and other information, or a pointing device, such as a mouse, a trackball, stylus, or cursor direction keys. Additionally, the system 400 as shown in FIG. 4 includes output devices 450. Examples of suitable output devices include speakers, printers, network interfaces, and monitors.

Display system 470 may include a liquid crystal display (LCD) or other suitable display device. Display system 470 receives textual and graphical information, and processes the information for output to the display device.

Peripherals 480 may include any type of computer support device to add additional functionality to the computer system. For example, peripheral device(s) 480 may include a modem or a router.

The components contained in the computer system 400 of FIG. 4 are those typically found in computer systems that may be suitable for use with embodiments of the present invention and are intended to represent a broad category of such computer components that are well known in the art. Thus, the computer system 400 of FIG. 4 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for dynamic asset allocation and visualization, the method comprising:
receiving input from a user via a graphic user interface, the user input specifying a starting asset amount, a minimum acceptable outcome, and a target outcome;
selecting an asset allocation based on the user input, wherein the asset allocation is selected to avoid falling below the minimum acceptable outcome and to maximize the likelihood of meeting the target outcome;
generating a visualization of a plurality of possible outcomes associated with the selected asset allocation over a predetermined time period, wherein the visualization includes:
a plurality of isopercentile lines that each correspond to a predetermined percentage range of the possible outcomes throughout the predetermined time period, and wherein each isopercentile line is at or above the minimum acceptable outcome; and
a histogram comprising a plurality of bars, each bar corresponding to a cumulative likelihood of each of the possible outcomes, wherein the histogram is aligned in accordance with the possible outcomes illustrated by the plurality of isopercentile lines; and
storing the selected asset allocation in a profile associated with a portfolio of the user.

2. The method of claim 1, wherein the input further includes a target date, wherein selecting the asset allocation is further based on the target date.

3. The method of claim 1, wherein selecting the asset allocation is based on a plurality of simulations each associated with a possible outcome.

4. The method of claim 3, further comprising filtering the simulations based on associated outcome falling at or above the minimum acceptable outcome, wherein generating the visualization is based on the filtered set of simulations.

5. The method of claim 4, further comprising selecting the asset allocation based on the filtered set of simulations, wherein the selected asset allocation is associated with a highest likelihood of meeting the target outcome.

6. The method of claim 1, wherein the generated visualization includes a line representing the minimum acceptable outcome, and wherein all of the isopercentile lines fall at or above the line representing the minimum acceptable outcome.

7. The method of claim 1, wherein one of the plurality of histogram bars is aligned to a line representing the target outcome and represents a highest likelihood among the plurality of histogram bars.

8. The method of claim 1, further comprising receiving new user input that includes an adjustment to at least one of the starting asset amount, the minimum acceptable outcome, and the target outcome, and automatically generating a new visualization based on the new user input.

9. The method of claim 1, further comprising receiving user input indicating approval of the selected asset allocation, and automatically initiating implementation of the selected asset allocation in real-time.

10. A system for dynamic asset allocation and visualization, the system comprising:
a user interface that receives input from a user regarding a starting asset amount, a minimum acceptable outcome, and a target outcome;
a processor that executes instructions stored in memory to:
select an asset allocation based on the user input, wherein the asset allocation is selected to avoid falling below the minimum acceptable outcome and to maximize the likelihood of meeting the target outcome, and
generate a visualization of a plurality of possible outcomes associated with the selected asset allocation over a predetermined time period, wherein the visualization includes:
a plurality of isopercentile lines that each correspond to a predetermined percentage range of the possible outcomes throughout the predetermined time period, and wherein each isopercentile line is at or above the minimum acceptable outcome; and
a histogram comprising a plurality of bars, each bar corresponding to a cumulative likelihood of each of the possible outcomes, wherein the histogram is aligned in accordance with the possible outcomes illustrated by the plurality of isopercentile lines; and
a database in memory that stores the selected asset allocation in a profile associated with a portfolio of the user.

11. The system of claim 10, wherein the input further includes a target date, wherein selecting the asset allocation is further based on the target date.

12. The system of claim 10, wherein selecting the asset allocation is based on a plurality of simulations each associated with a possible outcome.

13. The system of claim 12, wherein the processor executes further instructions to filter the simulations based on associated outcome falling at or above the minimum acceptable outcome, and to generate the visualization is based on the filtered set of simulations.

14. The system of claim 13, wherein the processor executes further instructions to select the asset allocation based on the filtered set of simulations, wherein the selected asset allocation is associated with a highest likelihood of meeting the target outcome.

15. The system of claim 10, wherein the generated visualization includes a line representing the minimum acceptable outcome, and wherein all of the isopercentile lines fall at or above the line representing the minimum acceptable outcome.

16. The system of claim 10, wherein one of the plurality of histogram bars is aligned to a line representing the target outcome and represents a highest likelihood among the plurality of histogram bars.

17. The system of claim 10, wherein the user interface further receives new user input that includes an adjustment to at least one of the starting asset amount, the minimum acceptable outcome, and the target outcome, and wherein the processor executes further instructions to automatically generate a new visualization based on the new user input.

18. The system of claim 10, wherein the user interface further receives user input indicating approval of the selected asset allocation, and wherein the processor executes further instructions to automatically initiate implementation of the selected asset allocation in real-time.

19. A non-transitory, computer-readable storage medium, having embodied thereon a program executable by a processor to perform a method for dynamic asset allocation and visualization, the method comprising:
receiving input from a user via a graphic user interface, the user input specifying a starting asset amount, a minimum acceptable outcome, and a target outcome;
selecting an asset allocation based on the user input, wherein the asset allocation is selected to avoid falling below the minimum acceptable outcome and to maximize the likelihood of meeting the target outcome;
generating a visualization of a plurality of possible outcomes associated with the selected asset allocation over a predetermined time period, wherein the visualization includes:
a plurality of isopercentile lines that each correspond to a predetermined percentage range of the possible outcomes throughout the predetermined time period, and wherein each isopercentile line is at or above the minimum acceptable outcome; and
a histogram comprising a plurality of bars, each bar corresponding to a cumulative likelihood of each of the possible outcomes, wherein the histogram is aligned in accordance with the possible outcomes illustrated by the plurality of isopercentile lines; and
storing the selected asset allocation in a profile associated with a portfolio of the user.
